(19) United States
(12) Patent Application Publication
(10) Pub. No.: US 2026/0237977 A1
(43) Pub. Date: Aug. 13, 2026

(54) TRANSFER SWITCH ASSEMBLY AND METHOD OF CONFIGURATION

(71) Applicant: Discovery Energy, LLC, Kohler, WI (US)

(72) Inventors: Nicholas FARACE, Kohler, WI (US); Mitchell DAVIDSON, Manitowoc, WI (US); Prathamesh GAIKWAD, Pune (IN); George WITT, Brillion, WI (US)

(73) Assignee: Discovery Energy, LLC, Kohler, WI (US)

(21) Appl. No.: 19/531,840

(22) Filed: Feb. 6, 2026

Related U.S. Application Data
(60) Provisional application No. 63/900,429, filed on Oct. 16, 2025.
(60) Provisional application No. 63/755,862, filed on Feb. 7, 2025.

(51) Int. Cl. H02B 1/04; H02B 1/32; H02B 3/00

(52) U.S. Cl. CPC H02B 1/04; H02B 1/32; H02B 3/00

(57) ABSTRACT

A transfer switch assembly including an enclosure having an upper compartment and a lower compartment separated by a horizontally oriented divider plate is disclosed. The upper compartment houses serviceable electrical components, such as a service entrance breaker, and the lower compartment houses restricted-access electrical components, such as auxiliary breakers, a battery charger breaker, a contactor, a control board, and wiring connectors. The divider plate comprises a panel with one or more frangible sections defined by pre-weakened perimeters. The frangible sections are selectively removable to form apertures for conductor passage between compartments, enabling either bottom-feed or top-feed wiring configurations while maintaining code-compliant compartment separation when intact. The divider plate may further include a neutral bond pass-through opening, structural ribs, and edge flanges, and may receive protective grommets or strain reliefs. An emergency stop switch may be mounted outside both compartments, such as at a corner of the enclosure, for multi-directional accessibility.

### CROSS-REFERENCE TO RELATED APPLICATIONS

This application claims priority under 35 U.S.C. §119(e) to U.S. Provisional Patent Application No. 63/755,862, entitled NEXT GEN PATENTABLE FEATURES EXPLORATION, filed on February 7, 2025, and U.S. Provisional Patent Application No. 63/900,429, entitled TRANSFER SWITCH ASSEMBLY AND METHOD OF CONFIGURATION, filed on October 16, 2025, the entire disclosures of which are incorporated by reference herein.

### FIELD OF INVENTION

The present disclosure relates to electrical power distribution equipment, and more particularly to transfer switch assemblies used to selectively connect electrical loads to one of multiple power sources.

### BACKGROUND

Transfer switch assemblies are used in conjunction with electrical power generation systems to selectively connect one or more electrical loads to a utility power source or to an auxiliary power source, such as a generator. In a typical residential or commercial standby power installation, a transfer switch assembly includes internal switching components configured to monitor the utility power supply and automatically transfer the load to a generator when the utility supply is interrupted or falls outside of an acceptable operating range. Automatic transfer switches (ATS) of this type are widely used in residential, commercial, and industrial settings, for example.

Transfer switch assemblies are subject to different electrical codes and certification requirements depending on the country or jurisdiction of installation. In the United States, transfer switches are commonly designed to comply with Underwriters Laboratories (UL) standards, and utility service lines often enter the transfer switch enclosure from below (bottom-feed configuration), such as when electrical service is provided via buried lines. In Canada, transfer switches are commonly designed to comply with Canadian Standards Association (CSA) standards, and utility service lines often enter from above (top-feed configuration). In CSA- compliant designs, the internal components are typically separated into distinct compartments by a continuous physical barrier, preventing the passage of conductors between compartments except for dedicated connections such as a neutral bond.

Manufacturers frequently supply transfer switch assemblies to both U.S. and Canadian markets, but conventional designs often require separate enclosure configurations for each jurisdiction. This increases manufacturing complexity, inventory requirements, and cost. For example, a CSA-compliant enclosure may include a solid divider plate between an upper compartment housing serviceable components and a lower compartment housing restricted-access components. Such a divider plate, however, prevents bottom-feed conductor routing without modification, complicating installation in jurisdictions where bottom-feed wiring is required. Conversely, a UL-compliant enclosure may include one or more pass-throughs sized to permit routing of conductors between compartments, but such openings must remain limited to conductor passage in order to maintain compliance; larger openings could compromise the required compartmental separation and prevent the enclosure from meeting CSA requirements.

Accordingly, there is a need for a transfer switch assembly that can be readily adapted to meet both UL and CSA requirements, allowing for top-feed or bottom-feed conductor routing as required, while maintaining appropriate compartment separation and electrical safety.

### BRIEF DESCRIPTION OF THE DRAWINGS

The present invention will become more fully understood from the detailed description and the accompanying drawings, wherein:

FIG. 1 is a perspective view of a transfer switch assembly according to an embodiment of the present disclosure illustrated with a door of the transfer switch assembly enclosure removed for the purpose of illustration;

FIG. 2 is a front view of the transfer switch assembly shown in FIG. 1, also illustrated with the door removed;

FIG. 3 is a rear view of the transfer switch assembly shown in FIG. 1;

FIG. 4 is a perspective view of a divider plate of the transfer switch assembly shown in FIGS. 1 and 2;

FIG. 5 is a top view of the divider plate shown in FIG. 3;

FIG. 6 is a front view of the divider plate shown in FIGS. 3 and 4;

FIG. 7A is a perspective view of the transfer switch assembly of FIG. 1 with the door in a closed position;

FIG. 7B is a perspective view of the transfer switch assembly of FIG. 1 with the door in an open position; and

FIG. 8 is a flow diagram of a method for configuring a transfer switch assembly according to an embodiment of the present disclosure.

### DETAILED DESCRIPTION

The following description of the embodiment(s) is merely exemplary in nature and is in no way intended to limit the invention, its application, or uses.

The description of illustrative embodiments according to principles of the present disclosure is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used in the present disclosure and claims, the singular forms “a”, “an” and “the” include plural forms unless the context clearly dictates otherwise.

It is understood that wherever embodiments are described herein with the language “comprising” otherwise analogous embodiments described in terms of “consisting of” and/or “consisting essentially of” are also provided. It is also understood that wherever embodiments are described herein with the language “consisting essentially of” otherwise analogous embodiments described in terms of “consisting of” are also provided.

The term “about” as used herein when referring to a measurable value such as an amount, a temporal duration, and the like, is meant to encompass variations of ±20%, ±10%, ±5%,, ±1%, or ±0.1% from the specified value, as such variations are appropriate to perform the disclosed methods. For recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6,9, and 7.0 are explicitly contemplated.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, “either,” “one of,” “only one of,” or “exactly one of.” “Consisting essentially of,” when used in the claims, shall have its ordinary meaning as used in the field of patent law.

The term “at least” prior to a number or series of numbers (e.g., “at least two”) is understood to include the number adjacent to the term “at least,” and all subsequent numbers or integers that could logically be included, as clear from context. When “at least” is present before a series of numbers or a range, it is understood that “at least” can modify each of the numbers in the series or range. Ranges provided herein are understood to include all individual integer values and all subranges within the ranges.

As used herein, the terms “comprising” (and any form of comprising, such as “comprise,” “comprises,” and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps.

“Optional” or “optionally” means that the subsequently described event, circumstance, or material may or may not occur or be present, and that the description includes instances where the event, circumstance, or material occurs or is present and instances where it does not occur or is not present.

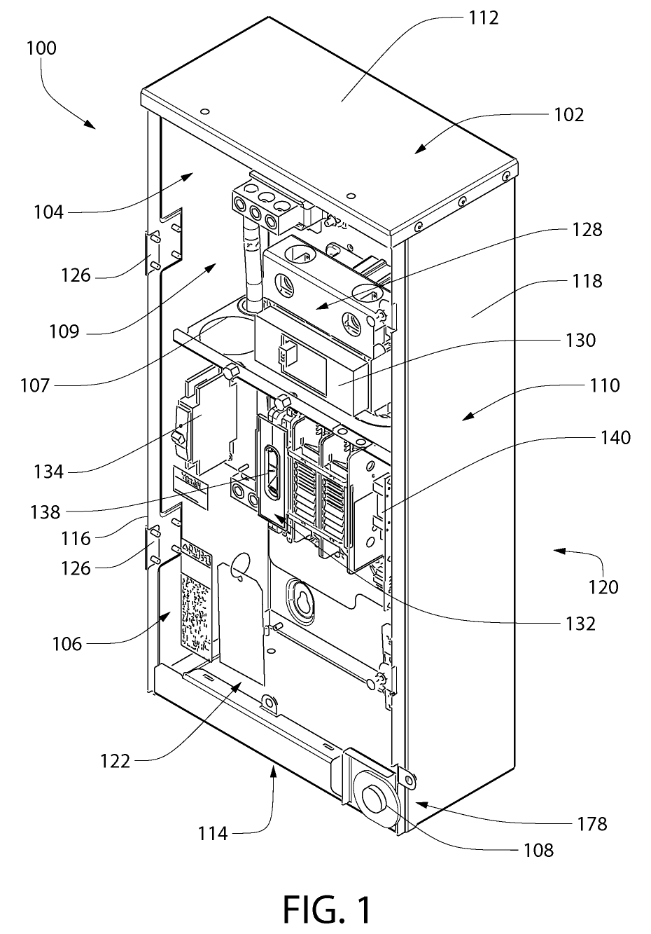

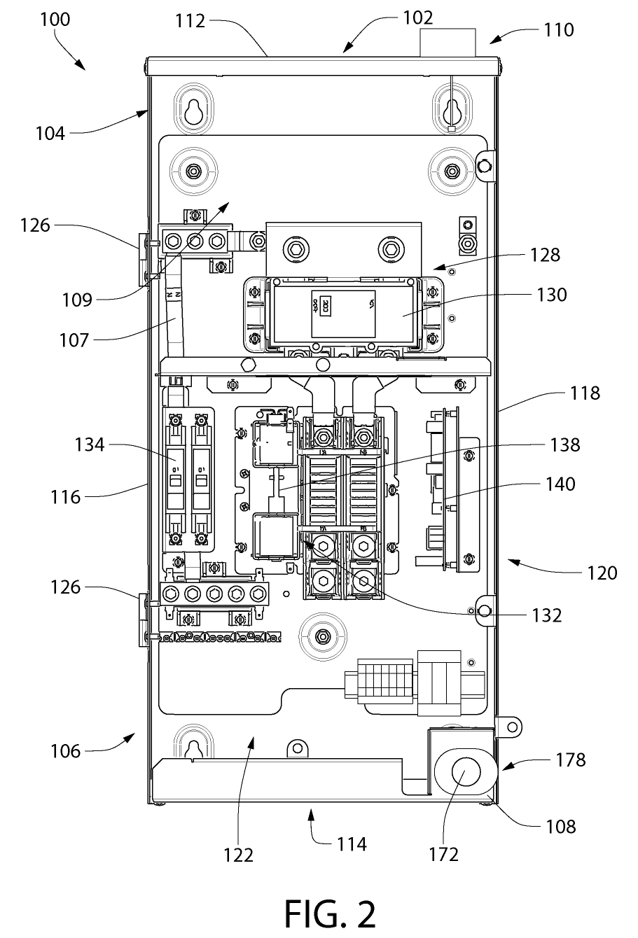

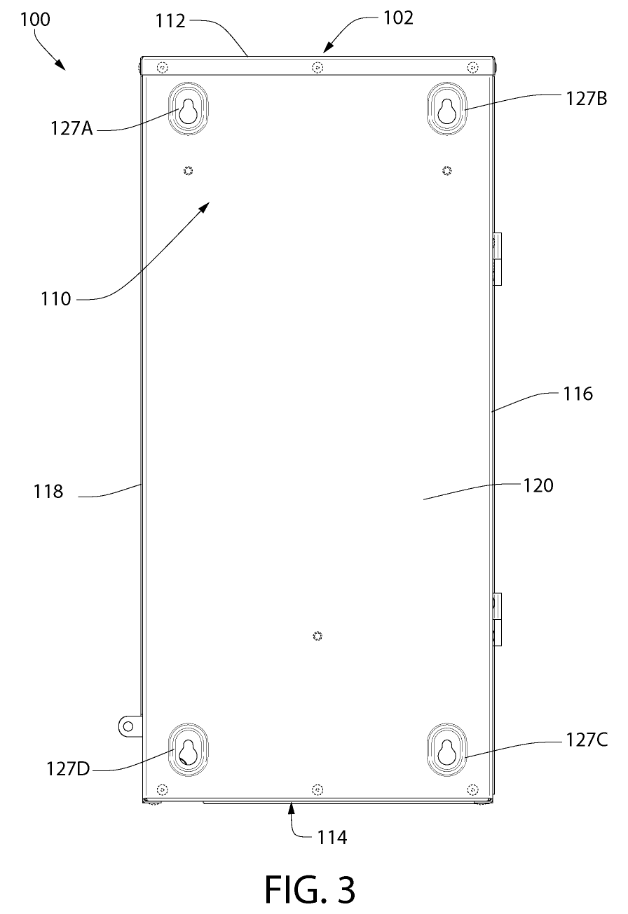

Referring to FIGS. 1-3, an embodiment of the present disclosure includes a transfer switch assembly 100. The transfer switch assembly 100 is configured for selectively connecting one or more electrical loads to a utility power source or to an auxiliary power source. In some embodiments, the auxiliary power source may be provided by an on-site generator, for example. In certain embodiments, the auxiliary power source may be provided by a battery energy storage system, a renewable energy system, and/or another independent power source, for example. The transfer switch assembly 100 is configured to automatically monitor the status of the utility power source and initiate transfer to the auxiliary power source in response to an interruption or degradation in the utility supply, and to transfer back when the utility supply is restored. In the illustrated embodiment, the transfer switch assembly 100 is embodied as an automatic transfer switch (ATS). In various embodiments, the transfer switch assembly 100 may be embodied as a manual transfer switch. In the illustrated embodiment, the transfer switch assembly 100 may be designed to be adaptable for compliance with different jurisdictional requirements, such as Underwriters Laboratories (UL) standards for installations in the United States and Canadian Standards Association (CSA) standards for installations in Canada, for example, enabling installation in either bottom-feed or top-feed configurations without requiring different enclosure designs.

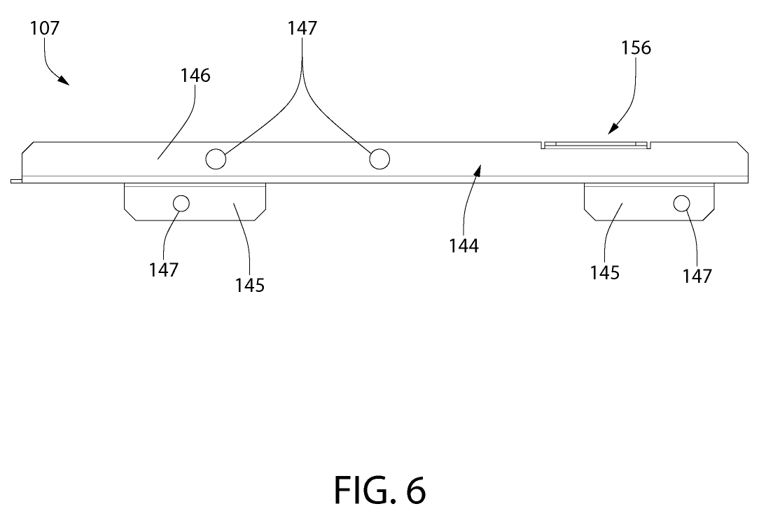

The transfer switch assembly 100 includes an enclosure 102 defining an upper compartment 104 and a lower compartment 106 separated by a horizontal divider plate 107. The enclosure 102 may be constructed from sheet metal (e.g., galvanized steel, cold-rolled steel, aluminum), molded polymeric material, and/or any other suitable material. The enclosure 102 defines an interior 109 and an exterior 110. In the illustrated embodiment, the enclosure 102 is generally rectangular in shape, for example, but can comprise any suitable shape. The enclosure 102 includes a top side 112, a bottom side 114, and opposed left and right sides 116, 118 extending between the top side 112 and the bottom side 114. As discussed further below, the divider plate 107 extends laterally between the left and right sides 116, 118. A rear side 120 spans between the top side 112, the bottom side 114, and the left and right sides 116, 118 and extends behind the divider plate 107. An open front side 122 provides access to the interior 109 of the enclosure 102; however, embodiments are envisioned in which the open front side 122 is enclosed by one or removable panels attached to, or fastened to, the enclosure 102. In addition to or in lieu of the removable panels, the enclosure 102 further includes a door 124 (shown in FIGS. 6A and 6B) movable between an open position in which the door 124 covers the open front side 122 and an open position in which at least a portion of the interior 109 of the enclosure 102 can be accessed.

In certain embodiments, the enclosure 102 may include gaskets, seals, and/or weatherproofing features extending around the open front side 122 and/or within the interface defined between the door 124 and the sides of the enclosure 102 which can limit the ingress of moisture and/or dust into the interior 109 of the enclosure 102. Further to the above, the enclosure 102 may be configured for surface mounting to a wall or structure, flush mounting within an opening, and/or free-standing installation. The rear side 120 includes one or more mounting structures 127 for securing the enclosure 102 in place. For example, in the illustrated embodiment, the rear side 120 includes four mounting structures 127A-127D disposed at corner regions of the rear side 120. The mounting structures 127 may include mounting flanges, brackets, and/or fastener openings.

The upper compartment 104 is configured to house one or more serviceable electrical components 128. As used herein, “serviceable electrical components” refers to components that are intended to be accessed, adjusted, and/or replaced by an installer, technician, or qualified end user, for example, during the normal operation and/or routine maintenance of the transfer switch assembly 100. Such components are typically positioned for convenient access through the door 124 and may be operated without exposing the user to live, uninsulated conductors, for example. In the illustrated embodiment, the upper compartment 104 includes a service entrance breaker 130 configured to connect or disconnect the load from the utility power source. The upper compartment 104 may additionally or alternatively house other electrical devices such as breakers, disconnect switches, and/or monitoring modules, for example. The upper compartment 104 may include mounting rails, brackets, and/or plates, for example, to support the components 128 and/or to route conductors within the upper compartment 104.

The lower compartment 106 is configured to house one or more restricted-access electrical components 132. As used herein, “restricted-access electrical components” refers to components that are not intended to be accessed, adjusted, and/or serviced by an end user during the normal operation of the transfer switch assembly 100, and whose exposure is generally limited to qualified personnel for maintenance, troubleshooting, and/or installation. Such components may be located behind barriers, within locked enclosures, and/or otherwise shielded to reduce the risk of accidental contact with live electrical parts. In the illustrated embodiment, the lower compartment 106 may include one or more auxiliary breakers 134, a battery charger breaker, a contactor 138, a control board 140, and/or one or more wiring connectors. The one or more wiring connectors may include terminal blocks, quick-connect fittings, and/or spring clamp connectors, for example.

The arrangement of components within the lower compartment 106 may vary between embodiments. For example, the control board 140 may be positioned on a vertical mounting plate adjacent the wiring connectors, or may be mounted horizontally on a shelf or bracket, for example. In the illustrated embodiment, the contactor 138 is oriented vertically the contactor 138 is oriented vertically to comply with space and wire bend requirements. In some embodiments, the contactor 138 may be oriented horizontally, and may be positioned for direct access to conductors passing between the compartments, for example, provided that applicable electrical codes and clearance requirements are met. The auxiliary breakers 134 and battery charger breaker may be ganged together on a single support rail or may be mounted separately, for example. Wiring connectors may be located along the bottom side 114 or rear side 120 of the enclosure 102 to facilitate conductor routing, for example.

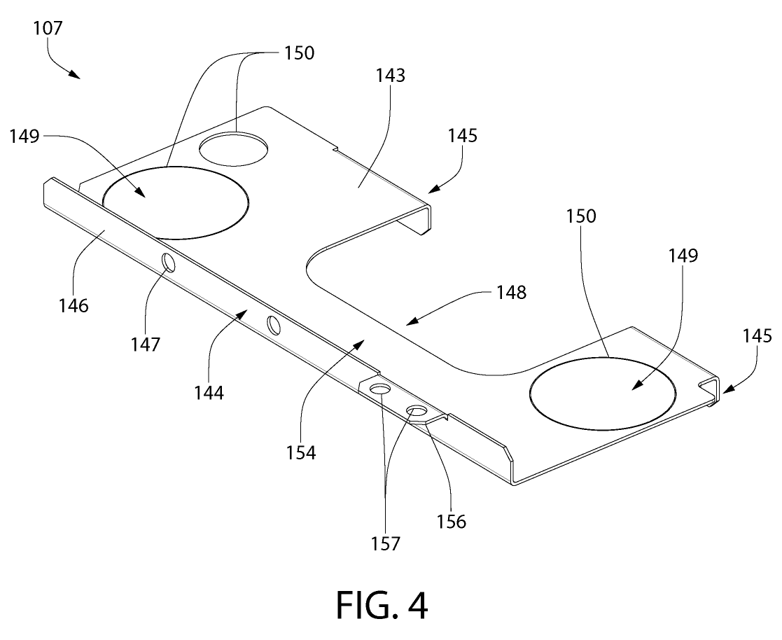

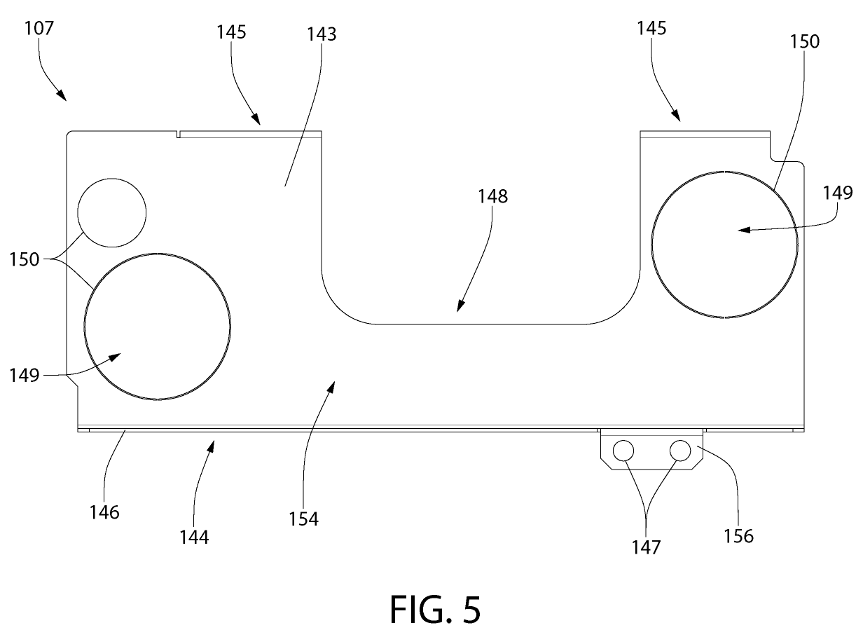

Referring to FIGS. 4-6, the divider plate 107 is a rigid, generally-planar member that extends laterally across the interior 103 of the enclosure 102 to physically separate the upper compartment 104 from the lower compartment 106. In the illustrated embodiment, the divider plate 107 comprises a panel 143 formed from a metallic sheet such as galvanized steel, cold- rolled steel, or aluminum, for example. In some embodiments, the divider plate 107 may be fabricated from a non-metallic insulating material (e.g., fiberglass-reinforced polymer) to meet electrical isolation requirements. In such embodiments, the upper compartment 104 can be mechanically and electrically isolated from the lower compartment 106 except for conductive wires extending between the upper compartment 104 and the lower compartment 106, as discussed in greater detail below. The panel 143 may be a unitary structure or may be formed from multiple joined sections, optionally including reinforcement features to increase rigidity and/or maintain flatness.

In the illustrated embodiment, the panel 143 has a generally-planar, substantially-rectangular main body with a front side 144 and a rear side 145. The panel 143 further includes at least one edge flange 146 extending from the front side 144, which in the illustrated embodiment is an upturned flange extending along an edge of the panel 143. The flange 146 may serve to stiffen the divider plate 107, align the plate 107 with the sides of the enclosure 102, and/or engage with complementary features of the enclosure 102 to form a seal or barrier. The flange 146 has one or more through-holes 147 defined therein that are sized to receive mechanical fasteners such as screws, bolts, rivets, rivet nuts, and/or alignment pins. In some embodiments, one or more flanges may extend downwardly, laterally, and/or along multiple edges of the panel 143, and may be continuous and/or segmented depending on structural and sealing requirements.

Further to the above, the rear side 145 comprises perpendicular mounting flanges including through-holes 147 defined therein which are configured to receive a lockout/tagout device, which when installed prevents removal of the upper inner panel 160 and thereby restricts access to components housed within the enclosure 102 in compliance with applicable safety standards. In some embodiments, apertures may also be positioned in mounting flanges to receive mechanical fasteners for securing the divider plate 107 to the enclosure 102. For example, the divider plate 107 may be mounted to the walls of the enclosure 102 via mechanical fasteners or any suitable joining method, such as welding, for example, and/or via one or more tab-and-slot arrangements.

The panel 143 may further define a recessed region 148 bounded by two opposing lateral extensions. This recessed region 148 may form a cutout extending inward from the rear side 145 toward the front side 144, such that a portion of the rear side 145 has a concave profile when viewed from above. In one example, the cutout may extend between two generally vertical side boundaries and terminate in a transverse inner boundary spaced from the rear edge. The resulting geometry may define a pair of outer rear corner portions that project rearward relative to the recessed central region. In various instances, the recessed region 148 is configured to closely receive one or more other components, such as electrical components, for example, of the transfer switch assembly 100 therein.

The divider plate 107 defines one or more frangible sections, or knock-outs, 149 configured to be selectively removed by an installer to create, when needed, an opening for routing electrical conductors between the upper compartment 104 and the lower compartment 106. The frangible sections 149 may facilitate the conversion of the transfer switch assembly 100 between top-feed and bottom-feed configurations while preserving a continuous physical barrier between the upper compartment 104 and the lower compartment 106 when the sections 149 are not removed from the divider plate 107, thereby maintaining compliance with applicable electrical code separation requirements.

Each frangible section 149 may be delineated by a pre-weakened perimeter 150, which may be formed by scoring, stamping, laser cutting, partial perforation, and/or any other suitable material reduction techniques to locally reduce the panel thickness. The frangible sections 149 may be circular, oval, polygonal, or irregular in shape, and may be arranged in one or more rows, columns, or patterns across the panel 143. In the illustrated embodiment, the frangible sections 149 are circular and positioned toward the lateral ends of the panel to accommodate conduit or cable entry from below. That said, the frangible sections 149 can comprise any suitable configuration and can be located in any suitable location in the panel 143.

The pre-weakened perimeters 150 are dimensioned to meet applicable mechanical strength requirements while allowing removal without damaging surrounding portions of the divider plate 107. In some embodiments, each frangible section 149 may be connected to the surrounding panel 143 by one or more retention tabs that bend or break during removal, allowing the broken section to remain partially attached to the panel so as to reduce the creation of loose debris within the enclosure 102.

The divider plate 107 further includes a central bridging region 154 extending between the frangible sections 149 across the width of the enclosure 102. The bridging region 154 physically separates the upper compartment 104 and lower compartment 106 when all of the frangible sections 149 are intact. The bridging region 154 may incorporate formed edges, ribs, and/or embossments, for example, to resist flexing and/or unintentional permanent deformation.

The divider plate 107 comprises one or more forward-extending integral flanges or tabs 156 extending from the panel 143. In various instances, further to the above, the tabs 156 can be used to support and/or align one or more covers, such as cover plates 160, 162, for example, mounted to the front of the enclosure 102, for example.

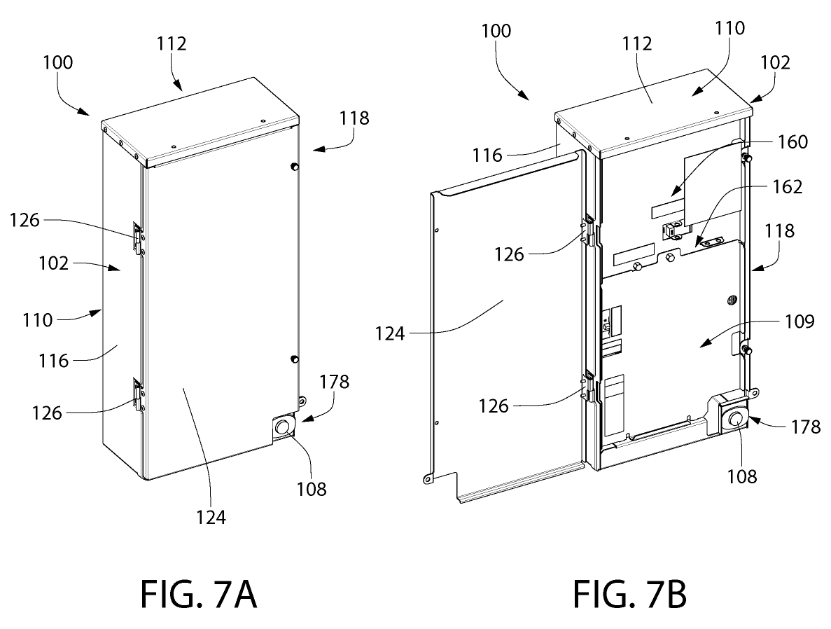

Referring to FIGS. 7A and 7B, in the illustrated embodiment, the door 124 is rotatably coupled to one of the sides of the enclosure 102 by one or more hinges 126 to allow pivoting movement of the door 124 between an open position and a closed position. In other embodiments, the door 124 may be removable, may be coupled to the enclosure 102 by a sliding track, and/or may be configured as a multi-panel or roll-up door. The door 124 may include a latch, lock, and/or other retention mechanism for securing it in the closed position, and may be constructed from the same material as the enclosure 102 and/or from another suitable material.

In the illustrated embodiment, further to the above, one or more internal cover plates 160, 162 may be mounted within the enclosure 102 behind the door 124 to shield and protect components housed in the respective compartments 104, 106. For example, a first cover plate 160 is removably secured over the upper compartment 104 while a second cover plate 162 is removably secured over the lower compartment 106 to cover bus bars, terminals, and/or other power distribution hardware, for example, contained therein. Each cover plate 160, 162 is sized and shaped to substantially enclose the open front side of its corresponding compartment 104, 106, and may include cutouts or access openings as needed. The cover plates 160, 162 are fastened to the enclosure 102 using screws, bolts, and/or any other suitable retention device, and are removable to permit maintenance or reconfiguration of the enclosed components.

Further to the above, the transfer switch assembly 100 is configured to receive an easily-accessible emergency stop (e-stop) switch 108. In the illustrated embodiment, the enclosure 102 includes a frangible portion that can be selectively removed to allow straightforward installation of the e-stop switch 108 at a designated location on the enclosure. When installed, the e-stop switch 108, when pushed or depressed, interrupts the flow of power through the transfer switch assembly 100, thereby providing rapid shutdown capability in emergency situations. The e-stop switch assembly 108 comprises an actuator 172, such as a mushroom-style push-button, for example, having an enlarged head that provides a large contact surface. The actuator 172 is biased toward an outward, “normally closed” position by one or more springs, for example, which are compressed when the actuator 172 is actuated to switch the e-stop switch 108 from its closed state into its open state. The e-stop switch 108 further comprises a latching mechanism that maintains the e-stop switch 108 in its open state once actuated. In various embodiments, the latching mechanism is resettable to allow the actuator 172 to return to its “normally closed” position and the e-stop 108 to return to its closed state. The actuator 172 may be colored, textured, and/or otherwise marked for high visibility in accordance with applicable safety standards (e.g., NEC, OSHA, IEC, or UL).

The actuator 172 may be operatively connected to a switch body housed within the enclosure 102, the switch body comprising electrical contacts rated to interrupt the maximum load current and voltage of the controlled circuit. In some embodiments, the contacts may be double-pole or multi-pole to simultaneously disconnect multiple conductors, such as both line and neutral.

The e-stop switch assembly 108 is mounted to a corner region 178 of the enclosure 102 such that the actuator 172 is accessible from the front and/or either side of the corner without requiring access through the upper compartment 104 or the lower compartment 106. In other embodiments, the e-stop switch assembly 108 may be mounted to a corner region such that the actuator 172 is accessible from either the upper compartment 104 or the lower compartment 106. In some embodiments, the actuator 172 may be positioned to extend through an opening aligned with both compartments, allowing operation from above or below the divider plate 107. The mounting location may be selected to avoid interference with conduit entries, access doors, or service panels while ensuring compliance with ergonomic reach requirements.

A sealing element, such as a gasket or O-ring, may be positioned between the actuator 172 and the enclosure 102 to inhibit the ingress of water and/or dust, for example, into the enclosure 102. In some embodiments, the e-stop switch assembly 108 may be configured for IP65, IP66, or higher protection ratings, for example.

Electrical conductors from the e-stop switch assembly 108 may be routed through the upper compartment 104, the lower compartment 106, or both, depending on the circuit configuration. If conductors pass between compartments, they may be routed through a neutral bond pass-through opening or an aperture created by removal of a frangible section 149, with appropriate strain relief devices or grommets installed.

In some embodiments, the e-stop switch assembly 108 may further include auxiliary contacts connected to a monitoring or alarm circuit. Activation of the actuator 172 may thus generate a control signal to a supervisory system, annunciator, and/or networked safety controller, for example.

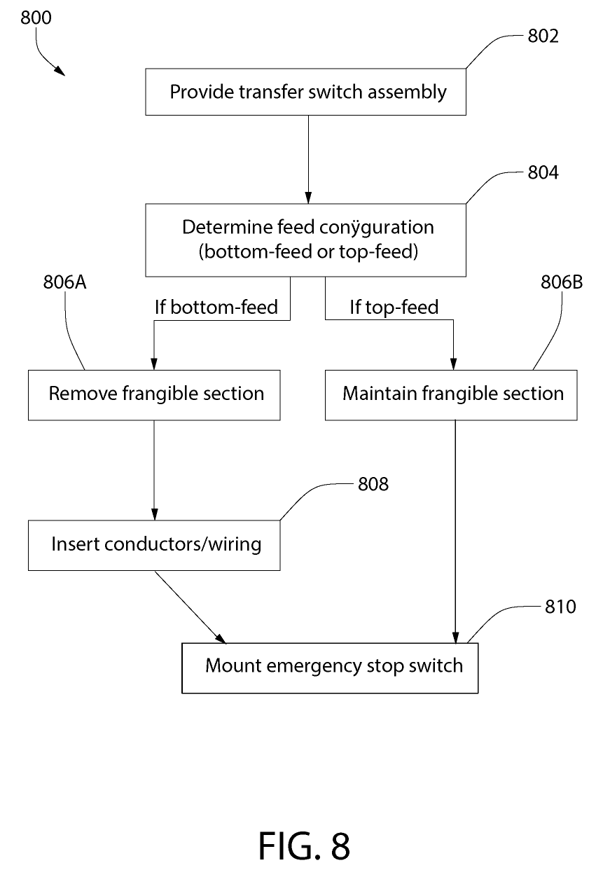

Referring to FIG. 8, a method 800 for configuring the transfer switch assembly 100 for installation is disclosed. The transfer switch assembly 100 may be installed in accordance with the electrical code requirements of the applicable jurisdiction. In step 802, the enclosure 102 may be provided, the enclosure 102 having the upper compartment 104 and lower compartment 106 separated by the divider plate 107. The divider plate 107 includes one or more frangible sections, or knock-outs, 149 as previously described.

In step 804, an installer may determine whether the incoming electrical service lines will enter the enclosure 102 from a top-feed configuration or a bottom-feed configuration. This determination may be based on the physical routing of the service conductors at the installation site, the local electrical code, and/or any applicable product listing or certification requirements (e.g., UL, CSA, or cULus compliance).

In step 806A, if the installation requires a bottom-feed configuration, the installer removes at least one frangible section 149 from the divider plate 107 to create an aperture. This removal may be performed using a hand tool, punch, or other suitable implement, applying force to the frangible section to break the pre-weakened perimeter 150. In step 808, the resulting aperture may allow passage of conductors and wiring between the lower compartment 106 and the upper compartment 104. In some embodiments, the installer may insert a protective grommet, strain relief, and/or bushing into the aperture to protect the conductors from abrasion and to satisfy applicable wiring protection requirements.

In step 806B, if the installation requires a top-feed configuration, such as when the service lines enter from above, the frangible sections 149 remain intact. In this state, the central bridging region 154 and flanges 146 may form a continuous physical barrier between the upper compartment 104 and lower compartment 106, maintaining the separation required by certain electrical codes (e.g., CSA) and preventing inadvertent access between compartments. The configuration may be finalized such that the same transfer switch assembly 100 can be installed, reconfigured, or operated in either a top-feed or bottom-feed configuration, or adapted for use in both, without requiring separate enclosure designs. This configuration may reduce manufacturing complexity, inventory requirements, and/or installation time.

Further to the above, the enclosure 102 can have one or more frangible sections, or knock-outs, in the exterior walls thereof that can be removed to permit conductors to be routed into the enclosure 102 as described above. For instance, the top side 112 of the enclosure 102 can comprise one or more removable knock-outs that can be removed to permit a top-feed arrangement and the bottom side 114 can comprise one or more removable knock-outs that can be removed to permit a bottom-feed arrangement. In some installations, both top and bottom-feed knock-outs may be used together, for example with utility service lines entering through the top side 112 and generator or emergency power lines entering through the bottom side 114. Load conductors routed out to a distribution panel may then pass through knock-outs in the bottom side 114, a bottom corner, or the rear side 120 of the enclosure 102 to align with the distribution panel when mounted on an opposite wall surface.

In step 810 an emergency stop switch 172 may be mounted to a corner location 174 of the enclosure 102. This location allows the emergency stop switch 172 to be accessible from outside both compartments and, in certain configurations, from multiple external sides of the enclosure. The emergency stop switch 172 may be electrically wired to de-energize the transfer switch assembly 100 and/or the connected generator system.

### Examples

Example 1. A transfer switch assembly comprising an enclosure, an upper compartment disposed within the enclosure and configured to house one or more serviceable electrical components, the one or more serviceable electrical components including a service entrance breaker, and a lower compartment disposed within the enclosure beneath the upper compartment and configured to house one or more restricted-access electrical components, the one or more restricted-access electrical components including an auxiliary breaker, a battery charger breaker, a contactor, a control board, and/or a wiring connector. The transfer switch assembly further comprises a horizontally-oriented divider plate disposed between the upper compartment and the lower compartment, the divider plate comprising a panel, at least one frangible section defined by a pre-weakened perimeter in the panel, the at least one frangible section configured to be manually removed to create an aperture through the divider plate for passing electrical conductors between the upper compartment and the lower compartment, and a central bridging region extending across the width of the enclosure to physically separate the upper and lower compartments in the absence of frangible section being removed.

Example 2. The transfer switch assembly of Example 1, wherein the enclosure includes a frangible portion configured to be removed to permit installation of an emergency stop switch, the emergency stop switch being disposed outside of both the upper compartment and the lower compartment.

Example 3. The transfer switch assembly of Example 2, wherein the emergency stop switch is accessible from either the upper compartment or the lower compartment.

Example 4. The transfer switch assembly of Example 2, wherein the emergency stop switch is mounted at a corner of the enclosure and is accessible from at least two exterior sides of the enclosure.

Example 5. The transfer switch assembly of Example 1, wherein the transfer switch assembly is an automatic transfer switch.

Example 6. The transfer switch assembly of Example 1, wherein each frangible section comprises a circular region surrounded by a score line or groove defining a reduced-thickness perimeter.

Example 7. The transfer switch assembly of Example 1, wherein the divider plate is formed from a stamped sheet metal material selected from the group consisting of galvanized steel, cold-rolled steel, and aluminum.

Example 8. The transfer switch assembly of Example 1, wherein the divider plate is fastened to the enclosure via mechanical fasteners extending through mounting holes formed along a bottom edge of the plate.

Example 9. The transfer switch assembly of Example 1, further comprising one or more structural ribs or bends formed into the divider plate to resist flexing.

Example 10. The transfer switch assembly of Example 1, wherein the enclosure is configured for code-compliant installation in either a bottom-feed or top-feed configuration, and the divider plate enables such compliance by allowing selective removal of the frangible sections.

Example 11. The transfer switch assembly of Example 1, further comprising a shielding element, grommet, or strain relief device mountable in the aperture formed by removal of a frangible section.

Example 12. The transfer switch assembly of Example 1, wherein the divider plate comprises a dedicated neutral bond pass-through opening distinct from the frangible sections.

Example 13. The transfer switch assembly of Example 1, wherein the divider plate forms a code-compliant barrier between the upper and lower compartments when all frangible sections remain intact.

Example 14. The transfer switch assembly of Example 1, wherein the frangible sections are aligned with locations on the enclosure configured to receive bottom-feed service lines.

Example 15. The transfer switch assembly of Example 1, wherein removal of a frangible section does not compromise electrical grounding continuity between the upper and lower compartments.

Example 16. The transfer switch assembly of Example 1, wherein the enclosure is part of a modular transfer switch assembly rated for cULus compliance.

Example 17. The transfer switch assembly of Example 1, wherein the at least one panel is a unitary panel.

Example 18. The transfer switch assembly of Example 1, wherein the at least one panel is comprised of metal.

Example 19. The transfer switch assembly of Example 1, wherein the at least one panel comprises at least one edge flange, and wherein the at least one edge flange is upturned.

Example 20. A method of configuring a transfer switch assembly for installation, the method comprising providing a transfer switch assembly comprising an upper compartment and a lower compartment separated by a divider plate having one or more frangible sections, determining whether one or more electrical service lines will enter the enclosure from a top-feed configuration or a bottom-feed configuration, in response to the determination removing at least one frangible section of the divider plate to form an aperture to create a conductor passage between the upper and lower compartments if bottom-feed wiring is required and leaving the frangible sections intact if top-feed wiring is required, thereby maintaining a continuous separation between the upper and lower compartments.

Example 21. The method of Example 20, wherein the upper compartment houses a service entrance breaker and is intended to be accessible to a user, and the lower compartment houses one or more of: a contactor, a control board, a breaker for a battery charger, and one or more wiring connectors.

Example 22. The method of Example 20, wherein the divider plate comprises a stamped metal panel having a central bridging region and a plurality of frangible sections defined by scored or grooved pre-weakened perimeters.

Example 23. The method of Example 20, further comprising connecting a neutral conductor through a dedicated neutral pass-through opening in the divider plate.

Example 24. The method of Example 20, wherein the transfer switch enclosure is installed in a configuration compliant with U.S. electrical code and the frangible section is removed to allow passage of conductors from a buried service line.

Example 25. The method of Example 20, further comprising providing an emergency stop switch to a corner of the enclosure, the switch being accessible from outside of both the upper and lower compartments.

Example 26. An automatic transfer switch assembly comprising a housing comprising an upper compartment and a lower restricted-access compartment, a manually-actuatable component in the upper compartment, a power supply component in the lower compartment, and a laterally-oriented divider disposed between the upper compartment and the lower compartment, the divider comprising a panel comprising a central bridging region and a knock-out section defined by a pre-weakened perimeter in the panel, wherein the knock-out section is configured to be removed to create an aperture through the divider for passing an electrical conductor between the upper compartment and the lower compartment to connect to the power supply component, and wherein the upper compartment and lower compartment are separated by the divider absent the removal of the knock-out section.

While the invention has been described with respect to specific examples including presently preferred modes of carrying out the invention, those skilled in the art will appreciate that there are numerous variations and permutations of the above-described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A transfer switch assembly, comprising:
an enclosure;
an upper compartment disposed within the enclosure and configured to house one or more serviceable electrical components, the one or more serviceable electrical components including a service entrance breaker;
a lower compartment disposed within the enclosure beneath the upper compartment and configured to house one or more restricted-access electrical components, the one or more restricted-access electrical components including:
an auxiliary breaker;
a battery charger breaker;
a contactor;
a control board; and/or
a wiring connector;
a horizontally-oriented divider plate disposed between the upper compartment and the lower compartment, the divider plate comprising:
a panel;
at least one frangible section defined by a pre-weakened perimeter in the panel, the at least one frangible section configured to be manually removed to create an aperture through the divider plate for passing electrical conductors between the upper compartment and the lower compartment; and
a central bridging region extending across the width of the enclosure to physically separate the upper and lower compartments in the absence of frangible section being removed.

2. The transfer switch assembly of claim 1, wherein the enclosure includes a frangible portion configured to be removed to permit installation of an emergency stop switch, the emergency stop switch being disposed outside of both the upper compartment and the lower compartment.

3. The transfer switch assembly of claim 2, wherein the emergency stop switch is accessible from either the upper compartment or the lower compartment.

4. The transfer switch assembly of claim 2, wherein the emergency stop switch is mounted at a corner of the enclosure and is accessible from at least two exterior sides of the enclosure.

5. The transfer switch assembly of claim 1, wherein the transfer switch assembly is an automatic transfer switch.

6. The transfer switch assembly of claim 1, wherein each frangible section comprises a circular region surrounded by a score line or groove defining a reduced-thickness perimeter.

7. The transfer switch assembly of claim 1, wherein the divider plate is formed from a stamped sheet metal material selected from the group consisting of galvanized steel, cold-rolled steel, and aluminum.

8. The transfer switch assembly of claim 1, wherein the divider plate is fastened to the enclosure via mechanical fasteners extending through mounting holes formed along a bottom edge of the plate.

9. The transfer switch assembly of claim 1, further comprising one or more structural ribs or bends formed into the divider plate to resist flexing.

10. The transfer switch assembly of claim 1, wherein the enclosure is configured for code-compliant installation in either a bottom-feed or top-feed configuration, and the divider plate enables such compliance by allowing selective removal of the frangible sections.

11. The transfer switch assembly of claim 1, further comprising a shielding element, grommet, or strain relief device mountable in the aperture formed by removal of a frangible section.

12. The transfer switch assembly of claim 1, wherein the divider plate comprises a dedicated neutral bond pass-through opening distinct from the frangible sections.

13. The transfer switch assembly of claim 1, wherein the divider plate forms a code-compliant barrier between the upper and lower compartments when all frangible sections remain intact.

14. The transfer switch assembly of claim 1, wherein the frangible sections are aligned with locations on the enclosure configured to receive bottom-feed service lines.

15. The transfer switch assembly of claim 1, wherein removal of a frangible section does not compromise electrical grounding continuity between the upper and lower compartments.

16. The transfer switch assembly of claim 1, wherein the enclosure is part of a modular transfer switch assembly rated for cULus compliance.

17. The transfer switch assembly of claim 1, wherein the at least one panel is a unitary panel.

18. The transfer switch assembly of claim 1, wherein the at least one panel is comprised of metal.

19. A method of configuring a transfer switch assembly for installation, the method comprising:
providing a transfer switch assembly comprising an upper compartment and a lower compartment separated by a divider plate having one or more frangible sections;
determining whether one or more electrical service lines will enter the enclosure from a top-feed configuration or a bottom-feed configuration;
in response to the determination:
removing at least one frangible section of the divider plate to form an aperture to create a conductor passage between the upper and lower compartments if bottom-feed wiring is required; and
leaving the frangible sections intact if top-feed wiring is required, thereby maintaining a continuous separation between the upper and lower compartments.

20. An automatic transfer switch assembly, comprising:
a housing comprising an upper compartment and a lower restricted-access compartment;
a manually-actuatable component in the upper compartment;
a power supply component in the lower compartment; and
a laterally-oriented divider disposed between the upper compartment and the lower compartment, the divider comprising:
a panel comprising a central bridging region; and
a knock-out section defined by a pre-weakened perimeter in the panel, wherein the knock-out section is configured to be removed to create an aperture through the divider for passing an electrical conductor between the upper compartment and the lower compartment to connect to the power supply component, and wherein the upper compartment and lower compartment are separated by the divider absent the removal of the knock-out section.
